(19) United States
(12) Patent Application Publication
(10) Pub. No.: US 2007/0091358 A1
(43) Pub. Date: Apr. 26, 2007

(54) Method for transmitting and printing a facsimile

(76) Inventors: Chung-Nan Tien, Yungho City (TW); Charles Hsieh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/512,292

(22) Filed: Aug. 30, 2006

(30) Foreign Application Priority Data
Oct. 20, 2005 (TW) 94136778

(51) Int. Cl. G06F 3/12

(52) U.S. Cl. 358/1.15; 358/400

(57) ABSTRACT

A method for transmitting and printing a facsimile is provided. The method is implemented in an electronic device, for example, a multifunctional peripheral. When the electronic device transmits a facsimile, a control unit is activated initially. Next, a scanner unit generates a piece of facsimile data, and then a facsimile number of a receiver is input via a control panel. Next, the facsimile data and the facsimile number are transmitted from the electronic device to a facsimile server via a client computer through a connection interface. Furthermore, when the electronic device prints a facsimile, the control unit is started up initially. Then, a piece of facsimile data is downloaded from the facsimile server to the electronic device via the client computer through the connection interface. Then, a print engine of the electronic device prints the facsimile data.

### RELATED APPLICATIONS

The present application is based on, and claims priority from, Taiwan Application Serial Number 94136778, filed Oct. 20, 2005, the disclosure of which is hereby incorporated by reference herein in its entirety.

### BACKGROUND

1. Field of Invention

The present invention relates to a method for transmitting and printing a facsimile, and more particularly, to a method for transmitting and printing a facsimile by an electronic device, for example, a multifunctional peripheral.

2. Description of Related Art

In recent years, both facsimile machines and computers can transmit and print out facsimiles. With the facsimile machine, a scanner unit of the facsimile machine converts the paper document into facsimile data and the facsimile number is then inputted from a facsimile control panel. Subsequently, the facsimile data can be delivered to a facsimile receiver. Generally, the facsimile machine is connected to a public switched telephone network (PSTN) and the facsimile transmission fee is the same as the voice telephone connection. On the other hand, with the computer, the facsimile data and the facsimile number are transmitted to a facsimile server via the Internet. After receiving the facsimile data and the facsimile number, the facsimile server completes the facsimile transmission via the PSTN.

Using a computer to transmit a facsimile via the Internet facsimile server has become more popular due to the widespread use of the Internet. In this way, users can transmit a facsimile without a telephone line and easily transmit a facsimile to several receivers simultaneously, so that the cost can be reduced.

In most cases, conventional methods to transmit a facsimile via the Internet facsimile server are complicated. This is because users have to operate a client computer connected with the facsimile server to finish a facsimile transmission. Users usually start the facsimile transmission by operating the client computer and a scanner thereof to scan a paper document and generate a piece of facsimile data, such as an image file. Then, the facsimile data and a receiver number are transmitted to the facsimile server by the client computer. On the other hand, users of the receiver also have to download the facsimile data from the facsimile server by operating a client computer and print the facsimile data by a printer. In these cases, users have to operate the client computer that is more complicated than a facsimile machine.

A multifunctional peripheral is an electronic device with scan, print, and facsimile functions. A conventional multifunctional peripheral generally transmits a facsimile via a PSTN, which is more costly than via the Internet. Users also can connect the multifunctional peripheral to a client computer and operate the client computer to transmit a facsimile via the Internet. However, it is also complicated. Therefore, how to provide a method for transmitting and printing a facsimile, which can decrease the cost and enhance the operating convenience of users, is an issue of great consequence.

### SUMMARY

The present invention provides a method implemented in an electronic device, such as a multifunctional peripheral. The electronic device can transmit and download a facsimile via an Internet facsimile server, in order to decrease the cost of transmitting and printing a facsimile.

It is another aspect of the present invention to provide a method implemented in an electronic device. The electronic device can transmit and download a facsimile without having to operate a client computer, so as to enhance the operating convenience for users.

Accordingly, the present invention provides a method for transmitting a facsimile. The method is implemented in an electronic device including a control panel, a scanner unit, a printer engine, a connection interface and a control unit. The method includes the following steps. Firstly, the electronic device activates the control unit. Next, the electronic device generates a piece of facsimile data with the scanner unit and inputs a facsimile number of a receiver by the control panel. Then the electronic device connects with a client computer of a facsimile server through the connection interface. Finally, the electronic device transmits the facsimile data and the facsimile number to the facsimile server via the client computer through the connection interface.

According to preferred embodiments, the electronic device is a multifunctional peripheral.

According to preferred embodiments, the connection interface is a USB interface, a parallel port interface, an IEEE1394 interface, an Ethernet interface or a bluetooth interface.

The present invention also provides a method for printing a facsimile. The method is implemented in an electronic device including a control panel, a scanner unit, a printer engine, a connection interface and a control unit. The method includes the following steps. Firstly, the electronic device activates the control unit. Next, the electronic device connects with a client computer of a facsimile server and downloads a piece of facsimile data from the facsimile server via the client computer through the connection interface. Finally, the electronic device prints the facsimile data by the printer engine.

According to preferred embodiments, the printer engine is a jet printer engine, a laser printer engine, a light emitting diode printer engine or a thermal printer engine.

The present invention also provides a method for transmitting a facsimile. The method is implemented in an electronic device including a control panel, a scanner unit, a printer engine, a network interface and a control unit. The method includes the following steps. Firstly, the electronic device activates the control unit. Next, the scanner unit of the electronic device generates a piece of facsimile data and the control panel of the electronic device inputs a facsimile number of a receiver. Then, the electronic device connects with a client computer of a facsimile server through the network interface. Finally, the electronic device transmits the facsimile data and the facsimile number to the facsimile server through the network interface.

The present invention also provides a method for printing a facsimile. The method is implemented in an electronic device including a control panel, a scanner unit, a printer engine, a network interface and a control unit. The method includes the following steps. Firstly, the electronic device activates the control unit. Next, the electronic device connects with a client computer of a facsimile server and downloads facsimile data from the facsimile server through the network interface. Finally, the printer engine of the electronic device prints the facsimile data.

According to preferred embodiments, the facsimile data and the facsimile number are transmitted to the facsimile server via the network interface using a TCP/IP protocol.

According to preferred embodiments, the TCP/IP protocol is a Simple Mail Transfer Protocol (SMTP), File Transfer Protocol (FTP) or Hypertext Transfer Protocol (HTTP).

It is to be understood that both the foregoing general description and the following detailed description are by examples and are intended to provide further explanations of the invention as claimed.

### BRIEF DESCRIPTION OF THE DRAWINGS

These and other features, aspects and advantages of the invention will become apparent by reference to the following description and accompanying drawings, which are given by way of illustration only, and thus are not limitative of the invention, wherein:

FIG. 1 is a block diagram of a facsimile system according to one preferred embodiment of the present invention;

FIG. 2 is a flowchart illustrating a method implemented in the electronic device in FIG. 1 to transmit a facsimile;

FIG. 3 is a flowchart illustrating a method implemented in the electronic device in FIG. 1 to print a facsimile;

FIG. 4 is a block diagram of a facsimile system according to another preferred embodiment of the present invention;

FIG. 5 is a flowchart illustrating a method implemented in the electronic device in FIG. 4 to transmit a facsimile; and

FIG. 6 is a flowchart illustrating a method implemented in the electronic device in FIG. 4 to print a facsimile.

### DESCRIPTION OF THE PREFERRED EMBODIMENTS

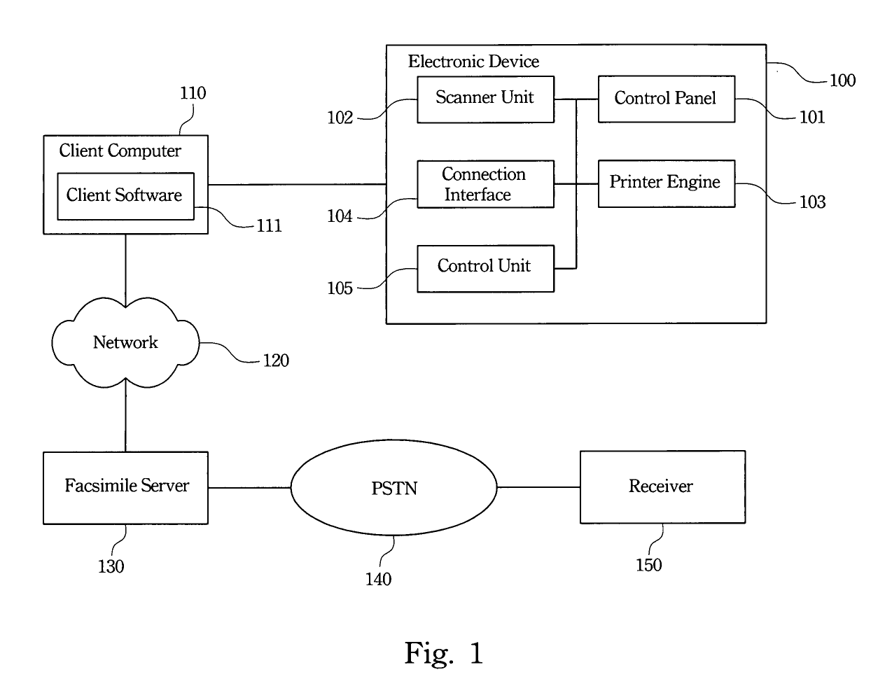

FIG. 1 is a block diagram of a facsimile system according to one preferred embodiment of the present invention. In FIG. 1, for example, the electronic device 100 is illustrated as a multifunctional peripheral including a control panel 101, a scanner unit 102, a printer engine 103, a connection interface 104 and a control unit 105. The control panel 101 including a liquid crystal display and a plurality of buttons is for presenting status information of the electronic device 100 and allowing users to input a facsimile number. The scanner unit 102 includes a backlight module and a plurality of complementary metal oxide semiconductor (CMOS) sensors. The scanner unit 102 is for providing a scanner function of the electronic device 100.

The printer engine 103, which allows users to print a facsimile, can be a jet printer engine, a laser printer engine, a light emitting diode printer engine or a thermal printer engine. The connection interface 104, which enables the electronic device 100 to connect with a client computer 110 of a facsimile server 130, can be a USB interface, a parallel port interface, an IEEE1394 interface, an Ethernet interface or a bluetooth interface. The control unit 105 includes a processor and a memory and controls the control panel 101, the scanner unit 102, the printer engine 103 and the connection interface 104, so as to integrate a scan function, a print function, a copy function and a facsimile function into the electronic device 100.

With continued reference to FIG. 1, the electronic device 100 uses the connection interface 104 to connect with a client computer 110. The client computer 110 is coupled with a facsimile server 130 via a network 120. The network 120 is, for example, a local area network (LAN), a wide area network (WAN), an intranet or the Internet. The facsimile server 130 connects with a receiver 150 via the PSTN 140. The client computer 110 has client software 111 which enables the electronic device 100 to communicate with the facsimile server 130.

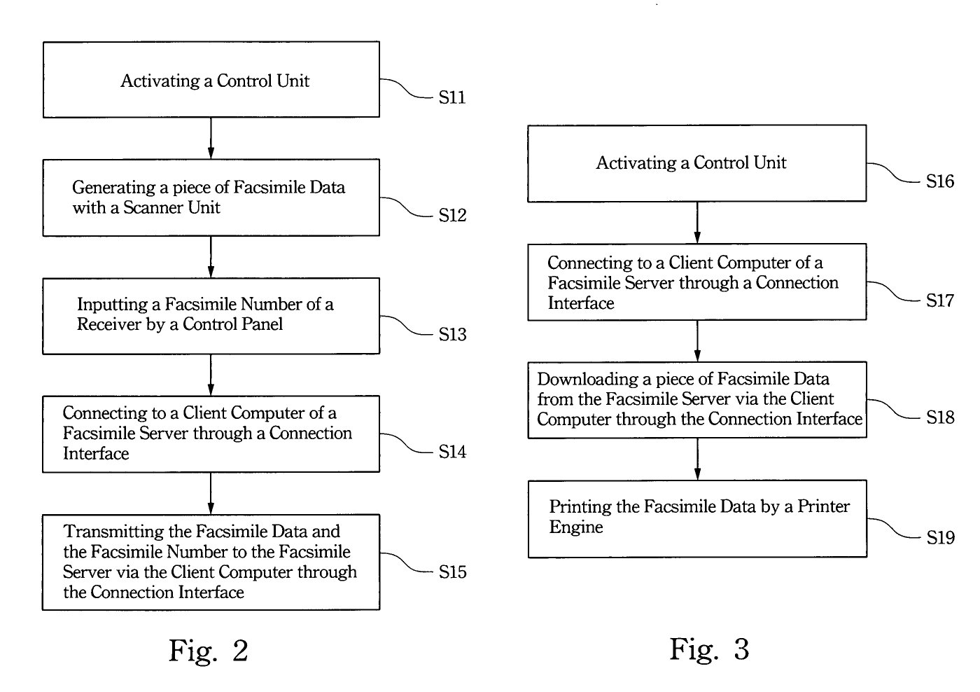

FIG. 2 is a flowchart illustrating a method implemented in the electronic device 100 in FIG. 1 to transmit a facsimile. Referring to FIG. 1 and FIG. 2, in step S11, the control unit 105 is activated to control the control panel 101, the scanner unit 102 and the connection interface 104. In step S12, the scanner unit 102 generates a piece of facsimile data. For example, the electronic device 100 generates facsimile data by scanning a paper document. The format of the facsimile date can be, for example, the Tag Image File Format (TIFF).

In step S13, a facsimile number of the receiver 150 is input via the control panel 101. Then, in step S14, the electronic device 100 connects to the client computer 110 through the connection interface 104. Finally, in step S15, the electronic device 100 transmits the facsimile data and the facsimile number to the facsimile server 130 via the client computer 110 through the connection interface 104, such that the facsimile server 130 can transmit the facsimile data to the receiver 150 according to the facsimile number via the PSTN 140.

FIG. 3 is a flowchart illustrating a method implemented in the electronic device 100 in FIG. 1 to print a facsimile. The method is executed when the facsimile server 130 receives a piece of facsimile data via the PSTN 140 and the electronic device 100 is utilized to print the facsimile data. Referring to FIG. 1 and FIG. 3, in step S16, the control unit 105 is activated to control the control panel 101, the scanner unit 102 and the connection interface 104. The method continues on to step S17, where the electronic device 100 connects to the client computer 110 through the connection interface 104. In step S18, the electronic device 100 downloads the facsimile data from the facsimile server 130 via the client computer 110 through the connection interface 104. Finally, in step S19, the electronic device 100 prints the facsimile data by the printer engine 103.

It is worth noting that the electronic device 100 can transmit and download a facsimile via the facsimile server 130 in the Internet, thereby decreasing the cost of transmitting and printing a facsimile. Further, users can transmit and download a facsimile by the control panel 101 and not need to operate the client computer 110, thus simplifying the process of transmitting and printing a facsimile via the facsimile server 130 and enhancing the operating convenience of users.

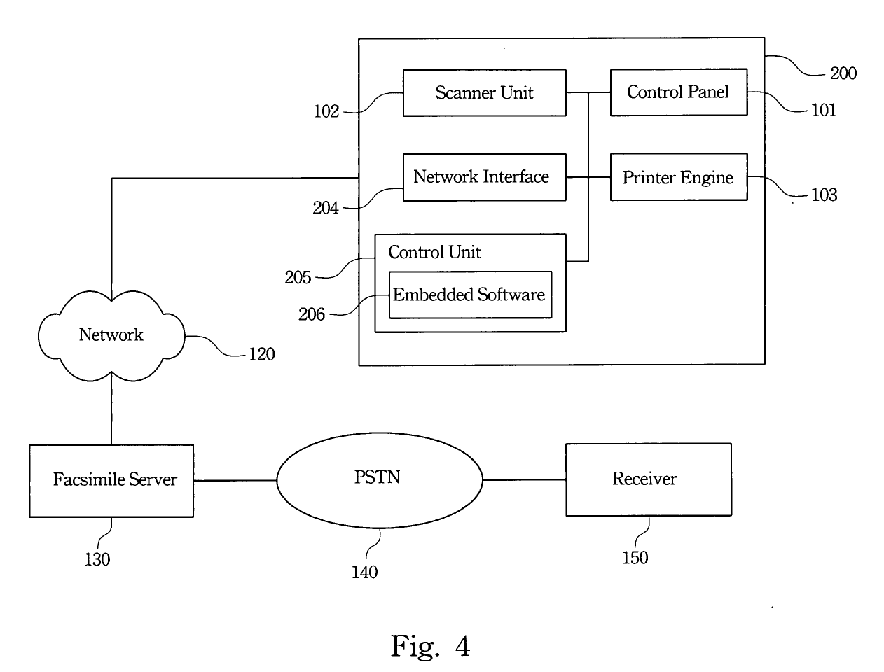

FIG. 4 is a block diagram of a facsimile system according to another preferred embodiment of the present invention. In FIG. 4, the electronic device 200 is illustrated as a multifunctional peripheral including a control panel 101, a scanner unit 102, a printer engine 103, a network interface 204 and a control unit 205. The network interface 204 supports a TCP/IP protocol and the control unit 205 has embedded software 206. The embedded software 206 is for connecting the electronic device 200 with the facsimile server 130. The facsimile server 130 is coupled with the receiver 150 via the PSTN 140.

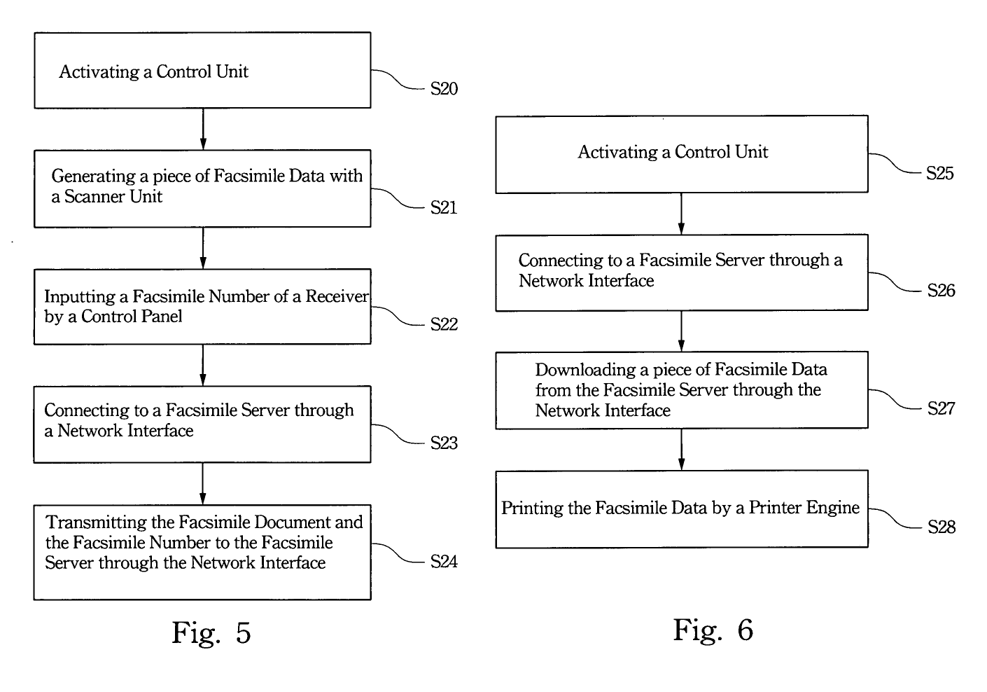

FIG. 5 is a flowchart illustrating a method implemented in the electronic device 200 in FIG. 4 to transmit a facsimile. Referring to FIG. 4 and FIG. 5, in step S20, the control unit 205 is activated to control the control panel 101, the scanner unit 102 and the network interface 204. The method continues on to step S21, where the electronic device 200 generates a piece of facsimile data with the scanner unit 102. For example, the electronic device 200 generates the facsimile data by scanning a paper document.

In step S22, a facsimile number of a receiver 150 is input via the control panel 101. Then, in step S23, the electronic device 200 connects with a facsimile server 130 through the network interface 204. Finally, in step S24, the electronic device 200 transmits the facsimile data and the facsimile number to the facsimile server 130 through the network interface 204, such that the facsimile server 130 can transmit the facsimile data to the receiver 150 according to the facsimile number via the PSTN 140. It should be noted that the facsimile data and the facsimile number are transmitted directly to the facsimile server 130 without having to be transmitted through a client computer. In a preferred embodiment, the electronic device 200 transmits the facsimile data and the facsimile number to the facsimile server 130 by the embedded software 206.

It is worth noting that the facsimile data and the facsimile number can be transmitted to the facsimile server 130 via the network interface 204 using a TCP/IP protocol. The TCP/IP protocol may be Simple Mail Transfer Protocol (SMTP), File Transfer Protocol (FTP) or Hypertext Transfer Protocol (HTTP).

FIG. 6 is a flowchart illustrating a method implemented in the electronic device 200 in FIG. 4 to print a facsimile. The method is executed when the facsimile server 130 receives a piece of facsimile data via the PSTN 140 and the electronic device 200 is used to print the facsimile data. Referring to FIG. 4 and FIG. 6, in step S25, the control unit 205 is activated to control the control panel 101, the scanner unit 102 and the network interface 204. The method continues on to step S26, where the electronic device 200 connects to a facsimile server 130 through the network interface 204. In step S27, the electronic device 200 downloads the facsimile data from the facsimile server 130 through the network interface 204. Finally, in step S28, the electronic device 200 prints the facsimile data by the printer engine 103. It should be noted that the electronic device 200 directly downloads the facsimile data from the facsimile server 130 without having to download the facsimile data through a client computer.

In these cases, the electronic device 200 can transmit and download a facsimile via the facsimile server 130 in the Internet, thereby decreasing the cost of transmitting and printing a facsimile. Further, users can transmit and download a facsimile by the control panel 101 and not need to operate a client computer, thus simplifying the process of transmitting and printing a facsimile via the facsimile server 130 and enhancing the operating convenience of users.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for transmitting a facsimile, implemented in an electronic device, wherein the electronic device includes a control panel, a scanner unit, a printer engine, a connection interface and a control unit, the method comprising:
activating the control unit;
generating a piece of facsimile data with the scanner unit;
inputting a facsimile number of a receiver by the control panel;
connecting with a client computer of a facsimile server through the connection interface; and
transmitting the facsimile data and the facsimile number to the facsimile server via the client computer through the connection interface.

2. The method for transmitting a facsimile of claim 1, wherein the electronic device is a multifunctional peripheral.

3. The method for transmitting a facsimile of claim 1, wherein the connection interface is a USB interface, a parallel port interface, an IEEE1394 interface, an Ethernet interface or a bluetooth interface.

4. A method for printing a facsimile, implemented in an electronic device, wherein the electronic device includes a control panel, a scanner unit, a printer engine, a connection interface and a control unit, the method comprising:
activating the control unit;
connecting with a client computer of a facsimile server through the connection interface;
downloading a piece of facsimile data from the facsimile server via the client computer through the connection interface; and
printing the facsimile data by the printer engine.

5. The method for printing a facsimile of claim 4, wherein the electronic device is a multifunctional peripheral.

6. The method for printing a facsimile of claim 4, wherein the printer engine is a jet printer engine, a laser printer engine, a light emitting diode printer engine or a thermal printer engine.

7. The method for printing a facsimile of claim 4, wherein the connection interface is a USB interface, a parallel port interface, an IEEE1394 interface, an Ethernet interface or a bluetooth interface.

8. A method for transmitting a facsimile, implemented in an electronic device, wherein the electronic device includes a control panel, a scanner unit, a printer engine, a network interface and a control unit, the method comprising:
activating the control unit;
generating a piece of facsimile data with the scanner unit;
inputting a facsimile number of a receiver by a control panel;
connecting with a facsimile server through the network interface; and
transmitting the facsimile data and the facsimile number to the facsimile server through the network interface.

9. The method for transmitting a facsimile of claim 8, wherein the electronic device is a multifunctional peripheral.

10. The method for transmitting a facsimile of claim 8, wherein the facsimile data and the facsimile number are transmitted to the facsimile server via the network interface using a TCP/IP protocol.

11. The method for transmitting a facsimile of claim 10, wherein the TCP/IP protocol is Simple Mail Transfer Protocol (SMTP), File Transfer Protocol (FTP) or Hypertext Transfer Protocol (HTTP).

12. A method for printing a facsimile, implemented in an electronic device, wherein the electronic device includes a control panel, a scanner unit, a printer engine, a network interface and a control unit, the method comprising:
activating the control unit;
connecting with a facsimile server through the network interface;
downloading a piece of facsimile data from the facsimile server through the network interface; and
printing the facsimile data by the printer engine.

13. The method for printing a facsimile of claim 12, wherein the electronic device is a multifunctional peripheral.

14. The method for printing a facsimile of claim 12, wherein the printer engine is a jet printer engine, a laser printer engine, a light emitting diode printer engine or a thermal printer engine.

15. The method for printing a facsimile of claim 12, wherein the facsimile data is downloaded from the facsimile server via the network interface using a TCP/IP protocol.

16. The method for printing a facsimile of claim 15, wherein the TCP/IP protocol is Simple Mail Transfer Protocol (SMTP), File Transfer Protocol (FTP) or Hypertext Transfer Protocol (HTTP).
